(19) United States
(12) Patent Application Publication
(10) Pub. No.: US 2004/0020773 A1
(43) Pub. Date: Feb. 5, 2004

(54) Apparatus and method for determining and/or monitoring electrophysiological properties of ion channels

(76) Inventors: Lars Thomsen, Aalborg OE (DK); Dirk Reuter, Ballerup (DK); John Dodgson, Hayes (GB); Anders Wolff, Lyngby (DK); Jamil El-Ali, Lyngby (DK)

Correspondence Address: BIRCH STEWART KOLASCH & BIRCH, PO BOX 747, FALLS CHURCH, VA, 22040-0747, US

(21) Appl. No.: 10/173,841

(22) Filed: Jun. 19, 2002

Related U.S. Application Data
(60) Provisional application No. 60/299,432, filed on Jun. 21, 2001.

(30) Foreign Application Priority Data
Jun. 20, 2001 (DK) PA 2001 00963

(51) Int. Cl. G01N 27/447

(52) U.S. Cl. 204/450; 204/403.01; 204/601

(57) ABSTRACT

An apparatus and method for determining and/or monitoring electrophysiological properties of ion channels of ion-channel containing structures uses AC driven location electrodes to drive objects for analysis to a measurement site. The measurement site may comprise an aperture between two solution-containing compartments, each compartment containing a respective measurement electrode. The aperture includes an adhesion region at its periphery and is dimensioned so that the object for analysis cannot pass through the aperture. Alternatively, the measurement site may comprise a measurement electrode surrounded by an adhesion region appropriately dimensioned to receive the object, to which the object may adhere, and a second measurement electrode remote therefrom.

### TECHNICAL FIELD

The present invention relates to an apparatus and a method for determining and/or monitoring electrophysiological properties of ion channels of ion channel-containing structures, typically lipid membrane-containing structures such as cells, by establishing an electrophysiological measuring configuration in which a cell membrane forms a high resistance seal around a measuring electrode, making it possible to determine and monitor a current flow through the cell membrane. The apparatus of the invention is typically part of a measuring system for studying electrical events in cell membranes, such as an apparatus for carrying out patch clamp techniques utilised to study ion transfer channels in biological membranes. More particularly, the invention relates to an apparatus for such a patch clamp measuring system having high throughput and utilising only small amounts of test compounds, only small amounts of liquid carrier, and being capable of carrying out many tests in a short period of time by performing parallel tests on a number of cells simultaneously and independently.

### BACKGROUND ART

The general idea of electrically insulating a patch of membrane and studying the ion channels in that patch under voltage-clamp conditions was outlined by Neher, Sakmann, and Steinback in “The Extracellular Patch Clamp, A Method For Resolving Currents Through Individual Open Channels In Biological Membranes”, Pflueger Arch. 375; 219-278, 1978. They found that, by pressing a pipette containing acetylcholine (ACh) against the surface of a muscle cell membrane, they could see discrete jumps in electrical current that were attributable to the opening and closing of ACh-activated ion channels. However, they were limited in their work by the fact that the resistance of the seal between the glass of the pipette and the membrane (10-50 MΩ) was very small relative to the resistance of the channel (10 GΩ). The electrical noise resulting from such a seal is inversely related to the resistance and was large enough to obscure the currents flowing through ion channels, the conductance of which are smaller than that of the ACh channel. It also prohibited the clamping of the voltage in the pipette to values different from that of the bath due to the large currents through the seal that would result.

It was then discovered that by fire polishing the glass pipettes and by applying suction to the interior of the pipette a seal of very high resistance (1-100 GΩ) could be obtained with the surface of the cell. This Giga-seal reduced the noise by an order of magnitude to levels at which most channels of biological interest can be studied and greatly extended the voltage range over which these studies could be made. This improved seal has been termed a “giga-seal”, and the pipette has been termed a “patch pipette”. A more detailed description of the giga-seal may be found in O. P. Hamill, A. Marty, E. Neher, B. Sakmann & F. J. Sigworth: “Improved patch-clamp techniques for high resolution current recordings from cells and cell-free membrane patches”, Pflügers Arch. 391, 85-100, 1981. For their work in developing the patch clamp technique, Neher and Sakmann were awarded the 1991 Nobel prize in Physiology and Medicine.

Ion channels are transmembrane proteins which catalyse transport of inorganic ions across cell membranes. The ion channels participate in processes as diverse as generating and timing action potentials, synaptic transmission, secretion of hormones, contraction of muscles, etc. Many drugs exert their specific effects via modulation of ion channels. Examples are antiepileptic compounds like phenytoin and lamotrigine which block voltage-dependent Na⁺-channels in the brain, antihypertensive drugs like nifedipine and diltiazem which block voltage dependent Ca²⁺-channels in smooth muscle cells, and stimulators of insulin release like glibenclamide and tolbutamide which block an ATP-regulated K⁺-channel in the pancreas. In addition to chemically induced modulation of ion-channel activity, the patch clamp technique has enabled scientists to perform manipulations with voltage dependent channels. These techniques include adjusting the polarity of the electrode in the patch pipette and altering the saline composition to moderate the free ion levels in the bath solution.

The patch clamp technique represents a major development in biology and medicine, since this technique allows measurement of ion flow through single ion channel proteins, and also allows the study of the single ion channel responses to drugs. Briefly, in standard patch clamp technique, a thin (app. 0.5-2 μm in diameter) glass pipette is used. The tip of this patch pipette is pressed against the surface of the cell membrane. The pipette tip seals tightly to the cell and isolates a few ion channel proteins in a tiny patch of membrane.

The activity of these channels can be measured individually (“single channel” recording) by removing the remaining parts of the cell or, alternatively, the patch can be ruptured (e.g. by applying subatmospheric pressure in the pipette) to give high-conductance access to the cell interior, so allowing measurements of the channel activity of the entire cell membrane (“whole cell” recording). An intermediate position between the two is the “cell-attached” mode, where the cell is attached to the pipette with a gigaseal but the patch of membrane inside the pipette remains intact.

During both single channel recording and whole-cell recording, the activity of individual channel subtypes can be characterised by imposing a “voltage clamp” across the membrane. In the voltage clamp technique the membrane current is recorded at a constant membrane potential. Or—to be more precise—the amplifier supplies exactly the current, which is necessary to keep the membrane potential at a level determined by the experimenter. Hence, currents resulting from opening and closing of ion channels are not allowed to recharge the membrane.

The time resolution and voltage control in such experiments are impressive, often in the msec or even μsec range. However, a major obstacle to use of the patch clamp technique as a general method in pharmacological screening has been the limited number of compounds that could be tested per day (typically no more than 1 or 2). Also, the very slow rate of solution change that can be accomplished around cells and patches may constitute a major obstacle.

A major limitation determining the throughput of the patch clamp technique is localisation and clamping of cells and pipette, and the nature of the solution feed system, which leads the dissolved compound to cells and patches.

In usual patch clamp setups, cells are placed in experimental chambers which are continuously perfused with a physiological salt solution. The establishment of the cell-pipette connection in these chambers is time-consuming and troublesome. Compounds are applied by changing the inlet to a valve connected to a small number of feed bottles. The required volumes of the supporting liquid and the sample to be tested are high.

High throughput systems for performing patch clamp measurements have been proposed, which typically consist of a substrate with a plurality of sites adapted to hold cells in a measuring configuration where the electrical properties of the cell membrane can be determined.

U.S. Pat. No. 5,187,096, Rensselaer, discloses an apparatus for monitoring cell-substrate impedance of cells. Cells are cultured directly on the electrodes which are then covered with a plurality of cells, thus, measurements on individual cells can not be performed.

WO 98/54294, Leland Stanford, discloses an apparatus comprising a substrate with wells containing electrode arrays. The substrate with wells and electrodes (metal electrodes) is made of silicon using CVD (Chemical Vapor Deposition) and etching techniques and comprises Silicon Nitride “passivation” layers surrounding the electrodes. The cells are cultivated directly on the electrode array. The substrate is adapted to measure electrophysiological properties and discloses a variety of proposed measuring schemes.

WO 99/66329, Cenes, discloses an apparatus comprising a substrate with perforations arranged in wells and electrodes provided on each side of the substrate. The substrate is made by perforating a silicon substrate with a laser and may be coated with anti-adhesive material on the surface. The substrate is adapted to establish giga seals with cells by positioning the cells on the perforations using suction creating a liquid flow through the perforations, providing the anti-adhesion layer surrounding the perforations, or by guiding the cells electrically. The cells can be permeabilised by EM fields or chemical methods in order to provide a whole-cell measuring configuration. All perforations, and hence all measurable cells, in a well share one working electrode and one reference electrode, see their FIG. 1, hence measurements on individual cells can not be performed.

WO 99/31503, Vogel et al., discloses a measuring device with an aperture arranged in a well on a substrate (carrier) and separating two compartments. The measuring device comprises two electrodes positioned on either side of the aperture and adapted to position a cell at the aperture opening. The substrate may have hydrophobic and hydrophilic regions in order to guide the positioning of the cells at the aperture opening. Cell positioning by means of electrophoretic movement of cells towards the aperture is also disclosed.

Manipulation of cells by Dielectrophoresis (DEP) is disclosed for example in U.S. Pat. No. 6,149,789, Benecke et al.; U.S. Pat. No. 5,454,472, Benecke et al.; U.S. Pat. No. 5,795,457, Pethig et al.; U.S. Pat. No. 5,858,192 Becker et al. and U.S. Pat. No. 6,059,950, Dames et al. The theory involved is described for example in U.S. Pat. No. 5,814,200, Pethig et al. and G. Fuhr et. al., ‘Cell motion in time-varying fields—principles and potential’, in ‘Electromanipulation of Cells’, U. Zimmerman, G. A. Neill, eds., CRC Press, Boca Raton, USA 1996.

Particles in a medium are polarised by an electric field applied to the medium and charges are induced at the particle boundaries. At the same time, if the medium is polarisable then charges will accumulate at the boundary of the medium adjacent the particle which will to a degree oppose those induced on the particle. If the particle has a greater polarisability than the medium then the net dipole, the sum of the dipole induced in the particle and that effectively present in the space in the medium occupied by the particle, will be parallel to the field; if the medium has greater polarisability than the particle the net dipole will be antiparallel. There will be a net force on the particle in a diverging field: a parallel dipole will give a net force towards regions of greater field—positive DEP; an antiparallel dipole will give a net force away from them—negative DEP.

In AC fields the polarisation of a particle, and hence the induced net dipole, will depend on frequency. The polarisation of the medium changes little. The time averaged DEP force will therefore also depend on frequency (and among other parameters, the conductivity and permittivity of the medium, the size, effective conductivity and permittivity of the particle). Cells and vesicles have membranes with complex dielectric properties which mean that at low and at high frequencies they appear to have lower polarisability than a typical aqueous medium of physiological conductivity, and at intermediate frequencies, higher polarisability. Therefore for a given medium in the correct conductivity range, it is possible to achieve negative DEP at low and high frequency and positive DEP at intermediate frequency with the same particle. Additionally, by using an electrode array in which electrode pairs are energised by AC potentials at a frequency in the negative DEP range to levitate the cells above the array, and with a chosen phase sequence, it is possible to exert a time-averaged force which moves through space above the electrode array, so causing the particle to move horizontally relative to the array. This can be used to achieve rotation (‘electrorotation’) or translation (‘Travelling Wave Dielectrophoresis’) (TWD) or to localise particles against movement by another force, for example flow of the surrounding medium.

U.S. Pat. No. 6,149,789, Benecke et al. discloses patterned electrode arrays that will move cells in a given direction, predetermined by the geometry of the array. This can be used to move cells to a give location or to separate different cells from a mixed population. In an aspect relevant to the present application, a ‘switchable filter’ is disclosed, where cells are moved to the centre of an array of concentric circular electrodes where they may flow through an aperture (under hydrostatic pressure) for the purpose of achieving separation of the cells from other types.

U.S. Pat. No. 5,454,472, Benecke et al. discloses further embodiments using the principle of TWD for continuous separation of particles. A TWD field in one direction is combined with a second force with a component in an orthogonal direction to move particles with selected properties out of a flow pattern followed by others. In particular an arrangement is disclosed in which particles are moved in a first compartment parallel to a substrate with apertures in it, by a TWD electrode array on that substrate. A second compartment is connected to the first through the apertures and an electrophoretic force is provided by a field perpendicular to the direction of motion of the TWD field between an electrode in the second compartment and another in the first, this field acting to draw particles through the apertures into the second compartment.

U.S. Pat. No. 5,795,457, Pethig et al. disclose means whereby reaction between particles suspended in a liquid can be brought about, reaction being defined broadly as covering chemical, biochemical or physical interactions, by means of applying more than one non-uniform field simultaneously to the suspension. Also disclosed in the concept of drawing off in this way is apparatus similar to the concept disclosed in U.S. Pat. No. 5,454,472, Benecke et al., above, where apertures are provided through which liquid and particle might pass, the difference from Benecke et al. being that an AC DEP field is used to move the particles through the apertures rather than an DC field.

U.S. Pat. No. 5,858,192 Becker et al. disclose a DEP cell manipulation device comprising a spiral electrode arrangement, which acts to direct cells by TWD towards or away from the centre of the spiral. A port at the centre is disclosed through which cells and liquid may pass. A sensing element, for example a biosensor, proximal the central port is disclosed.

U.S. Pat. No. 6,059,950, Dames et al. disclose a substantially similar spiral electrode array to Becker et al., the differences between the two disclosures being in the details of the method of energising the electrode.

U.S. Pat. No. 5,814,200, Pethig et al. disclose a further apparatus and method for cell sorting. This disclosure is useful as while it is not relevant in particular for the present invention, a summary of the theory of DEP established in the prior art is given.

### SUMMARY OF THE INVENTION

The present invention provides an apparatus and a method for making electrical measurements on ion channel-containing structures such as cell membranes and artificial membranes, which is capable of high throughput and substantially automated operation, is more reliable, and is capable of using substantially smaller amounts of test compound, than present apparatus.

The invention provides an apparatus comprising one or a plurality of measuring sites adapted to hold objects, such as cells, comprising an ion channel-containing membrane, such that the membrane forms a gigaseal against an adhesion region around a measuring electrode at the measuring site. This makes it possible to determine or monitor electrophysiological properties of the cell membrane using the measuring electrode and a reference electrode placed in a liquid surrounding the object. Alternatively, the measuring site may comprise an aperture, in which case the membrane forms a gigaseal around the aperture, the aperture communicating with a liquid-filled compartment in which the measuring electrode is located. The liquid will then contact the cell membrane through the aperture and measurements can be made in a similar way. The adhesion region may be of any shape—in preferred embodiments it will be approximately circular.

It will be understood that the term “object” as used in the present specification refers to any object comprising an ion channel-containing structure, such as an ion channel-containing lipid membrane or an ion channel-containing artificial membrane. A cell is an example of such a structure, and for clarity is used as such in the specification, particularly with reference to the prior art. Examples of electrophysiological properties are current flow through an ion channel or capacitance of an ion channel-containing membrane. Whole-cell and cell-attached configurations are considered as applying also to other closed objects comprising a membrane, such as vesicles.

The invention provides means to locate the object at the measurement site. In the prior art cited above, in which the measurement site comprises an aperture, location is achieved by moving the object towards the measurement site using for example entrainment of the object in liquid flow through the aperture, for example in U.S. Pat. No. 4,055,799 (Coster et al.), or by electrophoresis (EP), as disclosed in WO 99/31503 (Schmidt et al), by U.S. Pat. No. 5,506,141 (Weinreb et al) and by WO 01/25769 (Sophion), actuated by a DC field between the measuring electrode contacting the liquid-filled compartment beyond the aperture and the reference electrode contacting the liquid surrounding the object. This has a number of disadvantages. The object must have a net charge: this is true for the majority of cells, for example most eukaryotic cells have a negative surface charge at physiological pH of the surrounding medium, but for vesicles special processing steps are required to give a charged surface. DC potential difference between the electrodes will cause a DC current to flow, leading to Faradaic processes at the electrodes, which can be disadvantageous, leading for example to problems with the limited capacity of the material of reversible electrodes such as Ag/AgCl for transformation between oxidised and reduced forms (Ag to AgCl and vice-versa) and possibly electrolysis of the solution at irreversible electrodes such as Pt. The limited capacity of small reversible electrodes is particularly disadvantageous if the electrodes have to be very small, for example if a measuring electrode is to be surrounded by a gigaseal as disclosed in our earlier application WO 01/25769. Also, if an aperture is present, the location force, i.e. attraction of the object towards the oppositely charged electrode, is not self-cancelling at the aperture—the object will still experience an attractive force even when located at the aperture, and if it is sufficiently deformable may continue to move through the aperture (as is disclosed to happen for vesicles in WO 99/31503). This will introduce constraints on the field strength and hence the rate of movement of the objects, and may make necessary control means to detect the presence of the object at the aperture and turn off the field to prevent damage to the object.

The present invention discloses that objects are located advantageously at the aperture or measuring electrode by means of Dielectrophoresis (henceforward abbreviated as DEP). In the case that an aperture is present, this is achieved by applying an AC potential between the two electrodes in the solutions contacting opposing sides of the aperture; for a membrane that has significant AC resistance the AC field will be greatest and most divergent at the aperture, in the same manner as for the DC field used in WO 99/31503 and U.S. Pat. No. 5,506,141, and so objects in the vicinity of the aperture will have force exerted on them either towards it (in positive DEP) or away from it (in negative DEP). For embodiments which comprise a measuring electrode and where an aperture is not present, the AC potential is applied between the measuring electrode and a reference electrode in contact with the solution in which the objects are suspended.

As described for the prior art (see for example G. Fuhr et. al., ‘Cell motion in time-varying fields—principles and potential’, in ‘Electromanipulation of Cells’, U. Zimmerman, G. A. Neill, eds., CRC press, Boca Raton, USA 1996), the direction and relative magnitude of the force will depend on the AC frequency, the conductivity of the surrounding solution and the properties of the object. To effect positioning of the object at an aperture or measuring electrode, the AC frequency and conductivity of the solution will be determined according to the type of object in use to cause a positive DEP effect. DEP force is exerted only in regions of diverging field, and so once objects have reached a region of more uniform (albeit higher) field, for example in contact with an electrode or aperture towards which they are moving, the force they experience decreases. This is in contrast with the situation for location at an aperture by EP or suction, where the object will experience a greater force when it is located at an aperture than when it is near to, but separated from it. By design of the AC fields that the object will experience in different parts of the apparatus and at different times during its motion, DEP can be used to achieve much more precise location of an object than EP, for example by combination of positive and negative DEP effects.

The frequency of the AC field required to achieve positive and negative DEP forces on a given object can be estimated using prior art publications (see. e.g. Fuhr et al. above, FIG. 4). In general, if the conductivity of the surrounding medium is greater than that of the object interior, then only negative DEP is found at any frequency; if it is lower then positive DEP is found in general at higher frequencies, negative DEP at lower. Large positive DEP forces are found primarily when the conductivity of the medium is significantly less than that of the interior of the object. Therefore the method of object location using positive DEP according to the invention is preferably achieved using a suspension medium of conductivity lower than that of standard physiological medium, with the osmolarity of the medium controlled using inclusion of sugars such as mannitol, as known in the art, to maintain viability when the object is a cell, followed by replacement of the medium with a different solution closer to the normal physiological composition. The apparatus of the invention preferably includes means to deliver cells in the suspension medium and once a gigaseal has been achieved, to replace the solution efficiently. The optimum conductivity and frequency of operation for each embodiment of the invention will depend on the object in use. Typical ranges in which positive and negative DEP are described in the prior art are as follows. For typical mammalian cells, type MDA-MB-231 human breast cancer cells in medium of conductivity 56 mS/m, negative DEP and TWD effects are found in the range 10-100 kHz, positive DEP at higher frequencies. For medium at 406 mS/m, negative DEP and TWD in the range 30 kHz-10 MHz, positive DEP above that (U.S. Pat. No. 5,858,192, Becker et al.). For 3T3 fibroblasts in medium of conductivity 10 mS/m, the crossover frequency between negative and positive DEP is quoted as approximately 100 kHz in U.S. Pat. No. 6,149,789, Benecke et al.). The conductivity of 0.15 M NaCl solution, close to that in typical cell growth medium, is around 1400 mS/m.

The present invention provides for location of the object by Dielectrophoresis (DEP) using an AC field applied between the measuring electrode and the reference electrode, whether or not the measuring site comprises an aperture, or between any other pair combination of electrodes as might be provided for the purpose associated with the measuring site. DEP might be used alone, or in combination with other actuation means for moving the object, for example EP, entrainment in flow, gravitational or centrifugal sedimentation or magnetic location assisted by magnetic tagging of the object. Location of the object by DEP force comprises force acting directly on the object itself, or on an additional tagging entity associated with or attached to the object, or on the combination of the object and the tagging entity.

The process of location of the object comprises moving the object from the bulk of the suspending liquid to the vicinity of the measurement site, then moving the object to the site such as to establish a gigaseal at the site. The invention provides that one or both of these are achieved by DEP. For example, movement of the object from the bulk of the liquid to the site is envisaged as being by sedimentation or by positive DEP (as described for other applications in the prior art above); movement to establish the gigaseal by positive DEP or if an aperture is used, by entrainment in suction flow through the aperture. Additionally movement from the bulk towards the site can be achieved by negative DEP (Travelling Wave DEP, abbreviated as TWD) to cause lateral movement of the object relative to the surface on which the site is provided. Use of DEP to move the object close to an aperture, followed by suction down onto the aperture to form the seal, has the advantage of avoiding the need for large volume flows of liquid through the aperture and the significant pressure differential and time that this will require.

A further significant advantage provided by the invention is the possibility of using DEP to move objects towards a measuring site in preference to any debris present in the solution which may tend to adhere in the vicinity of the aperture or measuring electrode and so reduce the likelihood of achieving a gigaseal. The net time-averaged force on an object of characteristic dimension r (for example a sphere of radius r) moved through a liquid by DEP is proportional to r³, (see for example U.S. Pat No. 5,814,200, Pethig et al., and references cited therein) so the force increases greatly with size of the object. Most contamination in the solution will be smaller than the objects under test and so will experience a smaller force. Therefore debris will tend to move more slowly than the objects to be tested towards the measuring site, in contrast to movement by flow entrainment which will tend to move debris also.

In the case of an aperture, slight counterflow can be provided through the aperture (as is done in conventional electrophysiology experiments) to maintain a clear aperture and surrounding adhesion region, while the objects are moved towards the aperture using DEP. The lower DEP force on the debris will result in its being kept away by the liquid flow. In the case of a measuring electrode on the substrate, rapid movement by DEP of the object towards the electrode will reduce the chance of debris settling, slow fluid flow can be maintained over the surface of the electrode which will tend to prevent debris from settling, or the electrode can be operated in an orientation chosen to prevent debris settling. The counterflow through the aperture may be created by a hydrostatic pressure differential across the aperture. Alternatively it may be provided by electro-osmotic flow (EOF) between the two sides of the aperture, driven by a DC potential difference across it, superimposed on the AC DEP signal. For example, if the rear side of the aperture is held at a potential more positive than the front side, for an aperture material with positive coefficient of electroosmotic mobility, then liquid will flow through the aperture from rear to front. There will also be an EP effect on the object if this is charged, and enters the DC field, which for a negatively charged object such as a cell will also act to move the cell towards the aperture from the front side (i.e. in a direction opposite to the EOF direction), which may be advantageous. The size of the DC potential and AC DEP signal are chosen to give the optimum combination of these effects. If EP force acting on the object is not desired, then EOF can be generated using an electrode close to the aperture on the front side, so that the field penetrates little if any distance into the liquid.

The invention provides means to determine that a gigaseal has in fact been achieved, by monitoring the impedance between the measuring electrode at a measuring site and the reference electrode. The impedance measurement is optionally used to monitor the proximity of the object to the measuring site and, using feedback, to control the location process accordingly, both in terms of the force applied to the object and (in the case of an aperture) the choice of method of location—for example, the changeover if desired between DEP and suction. The application of counterflow through the aperture as described above is optionally also controlled in this way.

The invention also provides means to deliver test samples (typically pharmacological drug candidates) to each measurement site so that experiments can be carried out on each object held at the sites. The sample delivery means can be arranged to deliver individual samples to individual sites, or to have sites grouped such that the same sample is delivered to more than one of them. Such a group of sites within the apparatus of the invention is referred to as a test confinement.

The invention also provides means for carrying out a large number of individual experiments in a short period of time. This is accomplished by providing a system comprising a plurality of test confinements and a control unit that can coordinate the operation of the test confinements and associated functions. Each test confinement may comprise measurement sites, means for positioning an object at each site, for establishment of giga-seal, for selection of sites at which giga-seal has been established, measuring electrodes and one or more reference electrodes. Thereby it is possible to perform independent experiments in each test confinement. Due to the small size of the test confinements, the invention permits carrying out measurements utilising only small amounts of supporting liquid and test sample.

Therefore, according to one aspect, the present invention provides an apparatus for making electrical measurement on an ion channel-containing object in a medium, comprising:

a substrate having a first surface defining a boundary of a first compartment adapted for retaining a first solution, on which first surface is located one or more measurement sites, each site comprising: an aperture in the first surface communicating with a second compartment adapted for retaining a second solution; an adhesion region surrounding the aperture to which the object can adhere so as to form a high-resistance seal between the first compartment and the second compartment;

a first measurement electrode in said first compartment which, in use, contacts the first solution;

a second measurement electrode in the second compartment which, in use, contacts the second solution;

measuring means electrically connected to the first and second measurement electrodes adapted to make electrical measurements on the object adhered to the adhesion region at the measurement site; and

object location means, including a first location electrode in the first compartment, and adapted to provide an AC signal to the electrode in order to create an AC field in the first solution, which field acts to move the object towards the measurement site by dielectrophoresis.

In one arrangement, the first measurement electrode and the first location electrode may be formed as a single electrode structure. In another arrangement, the second measurement electrode and the first location electrode may be formed as a single electrode structure.

According to another aspect, the present invention provides an apparatus for making electrical measurement on an ion channel-containing object in a medium, comprising:

a substrate having a first surface which, in use, is contacted by a first solution, and on which is located one or more measurement sites, each site comprising: a first measurement electrode; an adhesion region surrounding the first measurement electrode to which the object can adhere so as to form a high-resistance seal between the first measurement electrode and the first solution; and a conductive track for connecting the first measurement electrode to a measuring instrument while keeping it insulated from the first solution;

a second measurement electrode which, in use, is in contact with the first solution;

measuring means, electrically connected to the first measurement electrode and the second measurement electrode, and adapted to make electrical measurements on an object adhered to the adhesion region at the measurement site;

object location means, including a first location electrode on the substrate and adapted to provide an AC signal to the location electrode in order to create an AC field in the first solution, which field acts to move the object towards the measurement site by dielectrophoresis.

In one arrangement, the first measurement electrode and the first location electrode may be formed as a single electrode structure. In another arrangement, the second measurement electrode and the first location electrode may be formed as a single electrode structure.

According to another aspect, the present invention provides a test structure for use in making an electrical measurement on an ion channel-containing object in a medium, comprising:

a substrate having a first surface on which is located one or more measurement sites, each measurement site comprising:

an aperture in the first surface communicating with a second surface of the substrate;

an adhesion region surrounding the aperture to which the object can adhere so as to form a high-resistance seal thereto;

at least one location electrode, substantially surrounding or adjacent to the adhesion layer region, configured for the application of an AC signal thereto so as to create an AC field in the proximity of the measurement site, which field acts to move an object towards the measurement site by dielectrophoresis.

In one arrangement, the test structure further comprises a first measurement electrode formed on or proximal to the first surface, and a second measurement electrode formed on or proximal to the second surface.

According to another aspect, the present invention provides a test structure for use in making an electrical measurement on an ion channel-containing object in a medium, comprising:

a substrate having a first surface on which is located one or more measurement sites, each measurement site comprising:

a first measurement electrode;

an adhesion region surrounding the first measurement electrode to which the object can adhere so as to form a high-resistance seal thereto;

at least one location electrode, substantially surrounding or adjacent to the adhesion layer region, configured for the application of an AC signal thereto so as to create an AC field in the proximity of the measurement site, which field acts to move an object towards the measurement site by dielectrophoresis, so that it adheres to the adhesion region to form a high-resistance seal.

In one arrangement, the test structure further comprises a second measurement electrode on the first surface separated from the first measurement electrode at least by the adhesion region.

According to another aspect, the present invention provides a method for making electrical measurements on an ion channel-containing object in a medium, comprising the steps of:

supplying a first solution comprising the objects to be measured in suspension to a first surface of a substrate, the substrate having an aperture therein communicating with a second surface of the substrate;

supplying a second solution to the second surface so as to establish fluid contact between the first and second surfaces;

testing that fluid contact has been achieved between first and second electrodes respectively located on or proximal to the first and second surfaces, by measuring electrical continuity therebetween;

driving an object to be measured in the first solution, to a measurement site having an adhesion region surrounding the aperture, by dielectrophoresis.

In another embodiment, the method provides the further step of testing the resistance of the seal at the measurement site on the substrate by measuring electrical impedance between said first and second electrodes. In another embodiment, the method provides the further step of establishing the measurement configuration for the object by means of one or more electrical pulses applied between the first and second electrodes, and performing measurements on said object.

According to another aspect, the present invention provides a method for making electrical measurements on an ion channel-containing object in a medium, comprising the steps of:

supplying a first solution comprising the objects to be measured in suspension to a first surface of a substrate, the substrate having a first measurement electrode located thereon, and an adhesion region surrounding said first electrode;

providing a second measurement electrode in electrical connection with the first solution; and

driving an object to be measured in the first solution to the measurement site by dielectrophoresis, to cause the object to adhere to the adhesion region so as to form a high-resistance seal therewith.

In another embodiment, the method provides the further step of testing the resistance of the seal at the measurement site on the substrate by measuring electrical impedance between said first and second electrodes. In another embodiment, the method provides the further step of establishing the measurement configuration for the object by means of one or more electrical pulses applied between the first and second electrodes, and performing measurements on said object.

An ion channel-containing object in a solution may be guided towards a measuring site on the substrate by DEP alone, by entrainment in flow in the first solution, or both. Flow in the first solution might be created by hydrostatic pressure differences applied from outside the substrate or by pumping action, from pump means located on the substrate or outside the substrate. Examples of suitable pumping means include electroosmotic flow, or other electrokinetic effects such as electrocapillarity, control of pressure from a pressurised fluid, creation of vapour or gas in a region in contact with the solution by chemical reaction or boiling, pumps driven by piezoelectric effects or other means as will be apparent to those skilled in the art.

The adhesion region provided at a measuring site might be the surface of the substrate itself, and is preferably patterned to give a localised adhesion region in the vicinity of the measuring electrode or the aperture, so as to minimise the possibility of an object adhering to a site without forming a gigaseal that entirely surrounds the measuring electrode or aperture. Alternatively, the substrate material might be such that a gigaseal does not form, and an adhesion layer, such as silica or a glass such as borosilicate known to form gigaseals to cells or vesicles, might be deposited and patterned adjacent the aperture.

In the present context, the term “giga-seal” normally indicates a seal of a least 1 G ohm, but for certain types of measurements where the currents are large, lower values may be sufficient.

The whole-cell configuration may be obtained by applying one pulse, or a series of potential difference pulses between the measuring electrode at a site at which an object is held with a gigaseal, and a reference electrode. If an aperture is present, the pulse(s) can be applied between the electrodes in contact with solution on either side of the aperture. Achievement of whole-cell mode is shown by monitoring the impedance of the object at the site—the capacitance between the electrodes will increase as the capacitance of the object membrane appears in the circuit. A series of pulses might be of increasing duration and/or potential difference with time until whole-cell mode is achieved. The process might be monitored by the system in order to learn which pulse protocol is most effective for a given object, and that protocol then be applied to all objects used in a given experiment.

Alternatively, the whole-cell configuration may be obtained by subjecting the part of the ion channel-containing structure which is closest to the measuring electrode to interaction with a pore forming substance.

As a further alternative, if an aperture is present the whole-cell configuration may be obtained by rupturing the part of the ion channel-containing structure surrounded by the gigaseal by means of a suction pulse applied through the aperture, using for example one of the pumping means described above.

In both the methods above, achievement of whole-cell mode can be monitored electrically, and the process controlled, as described for the electrical pulse method.

The use of other membrane configurations as known in the art of electrophysiology, such as ‘outside-out’ or ‘outside-in’ patches excised from the membrane, is also envisaged as part of the invention

Depending on the specific embodiment of the apparatus, in particular the substrate comprising the measuring sites, the addition of objects and supporting liquid is carried out in one of the following ways. In one embodiment, the test confinements are accessible from above, and droplets of supporting liquid and objects can be supplied at each test confinement by means of a dispensing or pipetting system. Systems such as an ink jet printer head or a bubble jet printer head can be used. Another possibility is an ‘nQUAD’ aspirate dispenser or any other dispensing/pipetting device adapted to dose small amounts of liquid. Alternatively, supporting liquid and objects are applied on the substrate as a whole (e.g. by pouring supporting liquid containing objects over the substrate or immersing the substrate in such), thereby providing supporting liquid and objects to each test confinement. If small volumes are to be used, handling of liquids on the substrate should preferably be carried out in high humidity atmospheres to avoid evaporation problems.

In a preferred embodiment each test confinement is a closed chamber accessed through one or more microchannels. This will give more control over interaction with the external environment and a more controlled and smaller volume of liquid application to the measuring site. More rapid changeover of test solutions will be obtainable than using pipette perfusion alone. In a particularly preferred embodiment, suspensions of test object and samples of test compounds are loaded sequentially into a microfluidic access channel from a liquid dispensing system, then flowed in sequence over the measuring site to a waste depot, preferably provided on the substrate or on a component mounted on or to the substrate.

In another aspect of the method, cells are cultivated directly on the substrate, while immersed in growth medium. In the optimal case, the cells will form a homogeneous monolayer (depending on the type of cells to be grown) on the entire surface, except at regions where the surface intentionally is made unsuitable for cell growth. However, in the present invention it is envisaged that a gigaseal is formed around each aperture contacting a common test confinement, so the formation of ‘tight junctions’ between the cells in the layer is not a necessity, unlike the situation disclosed in WO 99/66329 (Cenes).

In still another aspect of the method, an artificial membrane with incorporated ion channels may be used instead of a cell. Such an artificial membrane can be made from a saturated solution of lipids, by positioning a small lump of lipid over an aperture. This technique is thoroughly described in e.g. “Ion Channel Reconstitution” by Christopher Miller, Plenum 1986, p. 577. If the aperture size is appropriate, and a polar liquid such as water is present on both sides of the aperture, a lipid bilayer can form over the aperture. The next step is to incorporate a protein ion channel into the bilayer. This can be achieved by supplying lipid vesicles with incorporated ion channels on one side of the bilayer. The vesicles can be drawn to fusion with the bilayer by e.g. osmotic gradients, whereby the ion channels are incorporated into the bilayer. Alternatively, vesicles comprising ion channels can be located at the measuring sites individually.

### BRIEF DESCRIPTION OF THE FIGURES

Embodiments of the invention will now be described, by way of example only, with reference to the following figures in which:

FIG. 1a is a cross section of a first embodiment of an apparatus according to the invention showing in detail a measuring site;

FIG. 1b is a plan view of the apparatus shown in FIG. 1a;

FIG. 2 is a diagram of a measuring system comprising the apparatus shown in FIGS. 1a and 1b;

FIG. 3 is a cross section of a second embodiment of an apparatus showing in detail a measuring site;

FIG. 4 is a cross section of a third embodiment of an apparatus showing in detail a measuring site;

FIG. 5a is a cross section of a fourth embodiment of an apparatus showing in detail a measuring site;

FIG. 5b is a plan view of the apparatus shown in FIG. 5a;

FIG. 5c is a plan view of a fifth embodiment of an apparatus which in cross section also appears as in FIG. 5a;

FIG. 5d is a plan view of a sixth embodiment of an apparatus which in cross section also appears as in FIG. 5a;

FIG. 6a is a cross section of a seventh embodiment of an apparatus showing in detail a measuring site;

FIG. 6b is a plan view of the apparatus shown in FIG. 6a;

FIG. 7a is a cross section of an eighth embodiment of an apparatus showing in detail a measuring site;

FIG. 7b is a plan view of the apparatus shown in FIG. 7a;

FIG. 8 is a plan view of a ninth embodiment of an apparatus showing in detail a measuring site;

FIG. 9 is a cross section of a tenth embodiment of an apparatus showing in detail a measuring site;

FIG. 10 is a further cross section of the apparatus shown in FIG. 9, showing the features that surround the measuring site;

FIG. 11 is a cross section of an eleventh embodiment of an apparatus showing in detail a measuring site.

### DESCRIPTION OF PREFERRED EMBODIMENTS

FIG. 1a shows a cross-section and FIG. 1b a plan view of an embodiment of a measurement site according to the invention. A measurement site 1 which holds an object 2 to be tested is formed on a substrate 12. The measurement site comprises a first surface, on which one or more compartments or “test confinements” 36 each in the form of a well are defined, and a second surface comprising one or more second compartments 6. In the embodiment shown in FIG. 1 only a single test confinement and a single second compartment are shown, but it is understood that there may be a plurality of each provided on a single substrate, and more than one substrate may be provided in each apparatus. The test confinement 36 communicates with the second compartment by an aperture 30 formed in a separator membrane 4. The second compartment communicates with one or more liquid feed channels 7, defined either within the substrate 12 or by the alignment of features in one or both of the substrate and a backing or mounting member 10. An electrode 8 is provided in the test confinement 36 and a second electrode 16 is provided in the second compartment 6, that in use contact the liquids in the test confinement and the second compartment.

In use, the test confinement is filled with a liquid comprising the objects 2 and the second compartment is filled with an electrolyte to achieve liquid conductivity between the electrode 16 and the aperture 4. The object 2 is located at the aperture 30 by the location means of the invention and forms a gigaseal around it. In the embodiment in FIG. 1 the gigaseal is formed to the material 31 that forms the membrane 4, an adhesion region 18 being defined by a coating layer 46 to which objects do not adhere, that leaves exposed only an area of the material 31 adjacent the aperture. Alternatively, as shown in later embodiments, the material 31 might be such that a gigaseal does not form, and an adhesion layer might be deposited and patterned adjacent the aperture. If the substrate 12 is conductive, the electrode 16 and the contact electrolyte in the second compartment 6 might optionally be insulated from the substrate by an insulation layer 43, which itself might optionally be the same material 31 as that forming the membrane; this will allow more than one electrode 16 to be provided on a common substrate while remaining isolated from each other.

In some embodiments it is advantageous that the second compartments 6 and the electrodes 16 are electrically common; in which case the electrodes 16 are denoted as the reference electrodes. In others, the test confinements 36 are advantageously electrically common, and electrodes 8 are denoted the reference electrodes. While one of each of the electrodes 8 and 16 are shown in FIG. 1, fewer than one reference electrode per measurement site, or only one common reference electrode might be provided.

The apparatus shown in FIG. 1 can be fabricated in different ways from a variety of different materials. The essential feature is that the material adjacent the aperture in the adhesion region is suitable to form a gigaseal to an object comprising a lipid membrane. Such materials include silicon, plastics, pure silica and other glasses such as quartz or borosilicate, or silica doped with one or more dopants selected from the group of Be, Mg, Ca, B, Al, Ga, Ge, N, P, As and oxides from any of these. The adhesion material may itself form the membrane comprising an aperture, or may be deposited over or implanted into the membrane-forming material.

The minimum dimensions of the device are similar to those of the objects which are to be tested, so for example for typical mammalian cells of diameter of order 10 um the diameter of the gigaseal will preferably be 5 um or less. Therefore the diameter of the aperture where present is preferably 5 um or less, more preferably 2 um or less; the outside diameter of the adhesion region is preferably 10 um or less, the diameter of a measuring electrode where this is present, surrounded by an adhesion region, is preferably 5 um or less, more preferably 3 um or less. These dimensions will be larger if a larger object, for example an oocyte, is to be tested, smaller for a smaller object.

The dimensions are such that standard microfabrication methods, adapted for the purpose, are advantageous. A preferred method of fabrication of the embodiment in FIG. 1 is based on standard microfabrication processing technology as known in the art, using a silicon substrate 12. A typical sequence of processes is as follows:

1. Silicon nitride deposition (by Low pressure Chemical Vapour Deposition—LPCVD) onto both sides of a silicon wafer (12), preferably double side polished. This layer (31) forms the membrane comprising the aperture (30) on the front side, and forms an etch mask to define the rear side etch through the silicon.

2. Deposit Au/Cr onto the rear side of the wafer, then photolithography and etching to create an Au/Cr mask for etching of the silicon nitride to pattern the rear silicon hole etch.

3. Plasma etch nitride (CF4/02) to form the silicon etch mask.

4. KOH etch to form the rear well 6 (which will be pyramidal as shown in FIG. 1, as known in the art), and the membrane.

5. Back alignment IR photolithography—aligns front side masks to the rear etch mask. Pattern the aperture 30 in the front side.

6. Plasma etch nitride (CF4/02)—opens the aperture.

7. Deposition of optional insulating layer 43 if required over the exposed silicon on the rear side of compartment 6—silicon nitride by LPCVD.

8. Photolithography with SU-8—this applies a layer (46) of SU-8 photopatternable epoxy over the membrane to define the adhesion region 18.

9. Deposition of metal to form electrode 16 if required.

10. Part-saw the wafer for dicing after the last stage plasma clean.

11. Oxygen plasma clean—removes residues from the surface of the adhesion layer.

12. Mount the chip so formed into insulating housing components, for example moulded plastic components, to provide liquid delivery and handling, using for example capillary wicking of adhesive to join the silicon and plastic components, or heat sealing between the chip and the components.

The test confinements 36 can be defined by means of one or more insulating components mounted on or to the substrate 12, and can have an open form as shown in FIG. 1 or have liquid access to the test confinements by means of channels. In the simple open configuration in FIG. 1 the test confinement is defined by an insulating component 38, drawn in simplified form only to show its relation to the measurement site 1 and its function to bound the region of liquid applied to the test side of the device. The walls 37 of the test confinement are shown as vertical in the figure, but will advantageously in fact be sloping, or of variable profile, or undercut so as to be wider adjacent the plane of the membrane than at the opening, as suits the operation to add liquid and test objects suspended in liquid to the test confinement. The rear side of the substrate 12 can also have further components mounted on or to it, for example a component 10 which has one or more liquid channels 7 formed within it or acts in conjunction with the substrate 12 to form such channels.

Alternative embodiments (not shown) are also envisaged as part of the invention, which instead of a well 36 and associated electrodes comprise one or more flow channels which pass over the aperture, so allowing objects in suspension, and other solutions, to be delivered to the test object by flow rather than by pipetting. Such flow devices are known in the art, for example as disclosed in WO0020554 (AstraZeneca). Electrode 8 can then be included in contact with the flow channel as known in the art, either close to the aperture or remote from it, according to the desired operational characteristics of the device and the conductivity of the solution in use.

A measurement system according to the invention, which incorporates the measuring site apparatus shown in FIG. 1, is shown in FIG. 2. The measurement system 200 comprises:

the apparatus of FIG. 1, shown diagrammatically as 202, with a measuring site on a substrate 12 mounted in a component 10 which acts to define a flow-channel 7 accessing the second compartment 6 (FIG. 1), a test confinement on the front side accessed using a flow-through arrangement with liquid supplied via channel 204, an object 2 held in place at a measuring site and electrodes 8 and 16 in contact with the liquids on the two sides of the membrane;

an electrolyte reservoir 210 connected to the channel 7, the fluidic connection 214 being capable of supporting pressure and incorporating a pumping means 212 and means to create a differential pressure between the channel 7 on the rear side of the measuring site and the channel 204 on the front side. This means is shown in FIG. 2 as comprising a valve 216 but could equally comprise a further pump or means of applying a hydrostatic head, leading after the valve to a waste container 218 vented to atmosphere;

a further liquid supply means 220 for the front side, which acts to supply at least (i) a suspension of the objects to be tested, (ii) electrolyte for conductivity tests and (iii) compounds to be tested. Advantageously the liquid supply means comprises a liquid dispensing system which can supply the three types of liquid sequentially without air bubble entrainment, for example in turn comprising a tray 221 of liquid supplies and a sampler head 223 which can be moved to select the appropriate liquid sequence. The liquid supply means is connected via liquid supply connections 224 incorporating pumping means 222 to channel 204, and thence to a vented waste container 228;

a switching means 240 which can connect electrodes 8 and 16 to either an electrical measuring means 242, or a DEP signal generation means 246, or in certain circumstances to both means together; and

a control and recording means 248 which controls the operation of all parts of the system and records results from the measuring means.

Pumping means 212, 222 might comprise any practically applicable liquid displacement means as detailed in the description of the invention, and the pumping means might be incorporated in the liquid connection circuits 214, 224 wherever is practically appropriate.

The operating sequence of the system is as follows:

1. The apparatus 202 is primed first by flowing electrolyte from the reservoir 210 through the channel 7 before any liquid has flowed into the front side channel 204.

2. When the rear-side liquid circuit 214 is flushed and full, the valve 216 is closed and pumping means 212 operated so as to establish an overpressure above atmospheric in the circuit 214. The pressure required is not exact, but is sufficient to flush out air from the second compartment 6 in the apparatus shown in FIG. 1a, and to move electrolyte up to the aperture 30 in the membrane 4.

3. After this has been achieved, priming electrolyte is selected by the liquid dispensing system 220 and flowed through the channel 204.

4. The measuring means 242 then tests that continuity has been achieved through the aperture between the channels 204 and 7: i.e. that the apparatus is ready to receive a test object.

5. Valve 216 is then opened to equalise pressure between the front and the back of the aperture—alternatively a positive pressure is maintained by the pump to keep a slow through the aperture from the rear side to the front, which acts to avoid blockage of the aperture by debris;

6. Liquid dispensing system 220 selects suspension liquid containing test objects and flows this into channel 204.

7. Switching means 240 selects the DEP signal generator 246 which applies an AC signal to the electrodes at a frequency which causes a positive DEP force on the object, acting to draw the object towards the aperture until it adheres;

8. Preferably, measuring means 242 tests for the presence of the object at the aperture, by measuring the impedance of the aperture. Optionally the process of location of the object is controlled using feedback from the output of the measuring means to the location means.

9. The gigaseal may form spontaneously. Alternatively, formation may be assisted by application of slight negative pressure at the aperture, to suck the object down onto the sealing surface, or by application of a potential across the aperture, or both;

10. Measuring means 242 then tests for establishment of a gigaseal. Optionally, in the case that the gigaseal does not form spontaneously, the process may be controlled using feedback from the output of the measuring means.

11. Optionally, the whole-cell configuration is achieved by means described above, for example by application of transient negative pressure in channel 7;

12. Once the gigaseal and (optionally) whole-cell configuration are confirmed, the system starts a conventional experimental sequence of baseline and compound applications via the liquid dispensing system with control means 248 recording the results.

In practice further measurement sites will be incorporated in the system and the steps above will be followed for each site in the system. A degree of redundancy is expected—not every site will form a successful gigaseal to an object, or successful whole-cell measuring configuration where this is required, and these will be recorded by the system and excluded from the subsequent tests.

FIG. 3 shows an embodiment in which positive DEP is used to locate the object in a similar manner as in FIG. 1 but with the additional feature of at least one further electrode to facilitate object location. A further electrode 40 for use in DEP location of objects is formed on the surface of the membrane material 31. The electrode 40 is located around the aperture and is preferably circularly symmetric around it, for example in the form of a ring or arc, so as to give a strongly diverging field in the region of the aperture which is wholly or substantially symmetric about it. The electrode 40 is connected by means of a conductor track 41 which is contacted by appropriate contact means (not shown) to make electrical contact off-chip. The DEP electrode 40 is advantageously coated in at least the region around the aperture with a seal material 44 which is capable of forming a gigaseal to object 2. This then acts to form a gigaseal surrounding the aperture after the object has been attracted to the electrode by positive DEP. Areas of the material 31 outside the adhesion region are then advantageously coated with an insulating coating layer 46 to which objects do not seal readily, to reduce the likelihood of an object adhering to the seal region other than when it is centrally located. The diameter of the opening in the layer 46 is chosen to maximise the probability that an object that sticks will entirely cover the aperture, and that objects do not tend to adhere in such a way as to contact objects that seal to the aperture or to impede access to it. Therefore the diameter is preferably less than that of the test object, more preferably less than or equal to half the diameter of the object.

Another reason for advantage in coating electrode 40, and track 41, is to reduce the possibility of electrochemical reaction between them and the solution. In the embodiment shown in FIG. 3 the seal material 44 extends over an extended area of the chip surface and the coating material 46 lies over the seal material 44, the exposed area of which is defined by the extent of the opening in the coating material 46 adjacent the aperture. An additional advantage is gained if the coating layer 46 has appropriate dielectric properties to reduce significantly the field experienced by objects in the solution from the electrode 40 and the contact track 41 in those regions away from the aperture, so limiting strong positive DEP effects to the region adjacent to the aperture.

Other electrodes, for example for measurements, can be provided also on material 31 and isolated from solution by layer 46. This might be done for example to avoid the need for an electrode 8 formed or mounted on the upper component 38.

In use, objects deposited in well 36 in liquid (not shown) are drawn by positive DEP towards AC energised electrode 40. The second, or counter electrode for the AC DEP signal might be the electrode 8 or an alternative electrode located in contact with the solution in which objects are suspended. Those objects closest to electrode 40 will be drawn towards the electrode. As the electrode is at least substantially circularly symmetric around the aperture, and therefore so is the field, objects will tend to be drawn down towards the electrode in such a way that they settle onto it and cover the aperture. As the positive DEP force draws the object toward the electrode, it encounters the surface of the sealing material 44 which overlies the electrode and seals to it. Exactly central location of the object is not necessary provided that the aperture is covered and a gigaseal is achieved completely around it. Therefore the adhesion layer 44 must completely surround the aperture even if the electrode 40 does not. Once the seal has formed the signal creating positive DEP can be turned off if desired and the seal will hold the object in place.

The device of FIG. 3 is essentially similar to that in FIG. 1 and can be fabricated by a similar process with additional steps after step 6 in the earlier fabrication sequence:

6a. Deposit metal to form electrode 40 and contact track 41

6b. Photolithography to pattern electrode 40 and contact track

6c. Deposit isolation/adhesion layer 44—e.g. silica or glass by sputtering

FIG. 4 shows a further embodiment in which the central electrode is positioned on the underside of the membrane formed by material 31. This design is suitable for membranes that have good properties for transmission of electrical fields, for example that they are thin and/or have high relative dielectric constant. In this way the field lines from the electrode 40 pass through the membrane material and then diverge towards the distant reference electrode, causing the same positive DEP effect to draw objects down towards the electrode. Material 31 can therefore be used directly as the sealing surface for the object and no coating of sealing material over the electrode is necessary. Anti-adhesion material 46 is used to define the adhesion area to a ring adjacent the aperture as before. Electrode 40 is connected to the outside world by means of contact track 41, which preferably is insulated from the substrate 12 (in the event that the substrate is conductive) by an insulator layer 43.

In further alternative embodiments, the function of the electrode 40 on the underside of the membrane can be carried out by the electrode 16 in the well contacting the underside of the membrane. An AC potential applied to this electrode with respect to an electrode, for example electrode 8, contacting the solution on the upper side of the membrane can cause a positive DEP field through the orifice as described above with respect to FIG. 1, but it can also create a field through the membrane material 31 if that has favourable dielectric properties. These properties can be controlled by patterning areas of the membrane to give greater field transmission through a region adjacent the orifice than elsewhere, so limiting the DEP force to that region. A coating of insulating polymer surrounding the adhesion region can be used to achieve this.

In other preferred embodiments further electrodes are provided in order to cause motion of objects by DEP towards the aperture from areas remote from it. Positive DEP generated at or near the aperture will draw objects towards it, but at a distance from it the divergence of the positive DEP field, and hence the force acting on the particles, will be small. Movement of objects towards the aperture can be achieved using negative DEP in a linear array of electrodes using the Travelling Wave Dielectrophoresis (TWD) principle described in the prior art. Location of the object can then be achieved by positive DEP at the aperture as described for the embodiment shown in FIG. 1, by suction caused by flow through the aperture for example by hydrostatic pressure or electroosmotic flow, or a combination of positive DEP and flow. Advantageously an electrode 40 is provided adjacent the aperture, connected to a separate supply and energised to cause positive DEP towards it as in the embodiments above. For a given object type and solution, negative and positive DEP effects are created by applying low and high frequency fields respectively. The range of the fields is relatively short and so it is possible to apply a positive DEP field in a central region of the negative DEP TWD field without adversely affecting the latter. Alternatively, detection control means can be included to detect the presence of the object in the vicinity of the aperture and to initiate the positive DEP or suction location. Such means might include optical observation of the object near the aperture, and/or measurement of the electrical characteristics of one or more electrodes near the aperture.

FIG. 5 shows a preferred embodiment comprising a negative DEP TWD array to move objects towards the aperture. FIG. 5a is a cross-section at XX of the structure shown in plan in FIG. 5b. In the embodiment in FIG. 5a, in which the parts are numbered as in FIG. 3, additional electrodes 50a-h are shown to either side of the aperture. The structure shown in FIG. 5a forms part of the base of a well or a flow channel in the same manner as in FIG. 3, but the scale of the drawing is now such that only the floor of the well or channel is shown. Electrodes 50 form part of a TWD structure as known in the art, comprising an array of electrodes which are energised sequentially so as to cause negative dielectrophoretic suspension of objects above the array, and to cause them to move in the solution parallel to the array. The electrodes are arranged so that they are perpendicular to at least one axial direction which crosses the aperture, so leading objects towards it. The plan view FIG. 5b shows the aperture 30 surrounded by the electrode 40 connected by a track 41 to a bond pad; electrodes 50a-h are then arranged as arcs substantially surrounding the aperture, connected by conductor tracks 52a-h to further bond pads. Application of an appropriately chosen four-phase AC field to the electrodes following the manner disclosed for example in U.S. Pat. No. 6,149,789 (Benecke et al) or U.S. Pat. No. 5,795,457, (Pethig et al) will then drive the objects radially towards the centre of the arcs, i.e. the aperture. Electrode 40 is provided adjacent the aperture as before, and can be used for positive DEP attraction of the object to the aperture. Alternatively, if this aspect of the invention is not required, for example if positive DEP attraction via the aperture itself is to be used, then the inner electrode 40 can be omitted, or used as the inmost element of the TWD array.

The arrangement of electrodes and tracks in FIG. 5b is advantageous in that it only requires a single layer of conductor tracking, and no vias or crossovers. The number of electrodes arranged about the aperture is arbitrary, and is chosen according to the area in which an object is needed to be collected and moved towards the aperture. If the density of objects in the carrier solution is high, then a small radius of collection is sufficient, and relatively few electrodes are needed. In this case there are 8, which will be coupled in groups of 4 so as to achieve the optimum TWD field—namely, a and e, b and f, c and g, d and h will run in common. If a larger number of electrodes are required, then using two metallisation layers and vias to connect between them will be advantageous. FIG. 5c shows the same pattern of electrodes as FIG. 5b, now connected to fewer common conductor tracks: for example, electrodes 50a and 50e are connected to track 53a, 50b and 50f to track 53b, and so on. The tracks are isolated from each other by vias 55 leading to crossovers 57 in a second conductive track layer. If an increased number of electrodes is used in the array, then the common connection pattern will be extended such that every electrode is connected to one four electrodes further from the aperture, i.e. 50a, e, i, m, etc. (not shown) will all be connected to track 53a. Five tracks and bond pads will then suffice.

FIG. 5d shows a preferred embodiment in which the TWD array is arranged as a series of concentric circles, again contacted by conductor tracks on a second conductive layer isolated from the first. This arrangement has the advantage that there is no area where the TWD does not function, as it does not in the area of the contact tracks in FIGS. 5b and 5c. The concentric electrodes are connected by vias 55 to conductive tracks 53 which are on a second, lower, level in the structure. The electrodes are connected to their respective conductor tracks in the same manner as for the embodiment in FIG. 5c.

In a further preferred embodiment shown in plan in FIG. 6b and in cross section at X-X on the plan in FIG. 6a, the electrodes are arranged in a spiral as disclosed in U.S. Pat. No. 5,858,192, (Becker et al) and U.S. Pat. No. 6,059,950, (Dames et al), four electrodes 60, 62, 64 and 66 being provided in an interleaved arrangement and fed via connector tracks 61, 63, 65, and 67 respectively from an AC source such that there is a cumulative 90 degree phase difference between neighbours. This causes objects to move towards the centre of the spiral along a radial path. An object is then located at the aperture by the means stated above.

FIG. 7b shows a plan and FIG. 7a a cross-section at X-X on the plan of a further preferred embodiment, in which a spiral TWD array is provided as in the embodiment shown in FIG. 6, with additionally a central electrode 40 provided for positive DEP location of an object at the aperture (aperture not shown in FIG. 7b). The electrodes 60, 62, 64, 66 are connected to tracks 61-67 as before, except now there is a fifth spiral electrode in the group, which comprises conductor track 41, interleaved between two of the TWD spiral electrodes, leading to the ring electrode 40 around the aperture. This is a particularly advantageous arrangement of electrodes to connect the central electrode 40 without a second level conductive layer. However, track 41 can be led to electrode 40 on a second level underlying the spiral electrodes 60-66 if desired.

Other configurations of the TWD array which will act to move objects towards an aperture are envisaged as part of the invention. The embodiments described above have arrays disposed substantially around the aperture which will move objects towards it from a large angular range. However, embodiments comprising arrays which move objects from one or more primary directions are also envisaged. For example, FIG. 8 shows in plan view a device in which objects are moved through a channel 90 by TWD using an array of electrodes 80, 82, 84, 86 and so on, driven from four AC lines 81, 83, 85, 87 connected as known in the prior art, for example U.S. Pat. No. 6,149,789, (Benecke et al) or U.S. Pat. No. 5,795,457, (Pethig et al), so as to deliver an object to an aperture 30. The aperture is preferably placed in a region in which the channel narrows as shown in FIG. 8. The connection to the drive lines requires two levels of contact layer with vias 89 leading between the two. Alternative configurations of connection will be apparent to those skilled in the art.

A further embodiment of the invention is shown in FIGS. 9 and 10, in which positive DEP is used to locate an object at a planar electrode instead of an aperture. FIG. 10 shows a measurement site 100 which is located on a substrate 102. FIG. 9 shows the measurement site in close up; FIG. 10 shows the measurement site as part of a test device 104 comprising the substrate 102 with the measurement site; a component 106 either formed as part of the substrate or mounted on it which defines a test confinement in the form of a well 120 in which the measurement site 100 is located; a reference electrode 108 mounted in the well so as to contact liquid within it, connected by a conducting track 110 to a contact area 112 kept remote from solution and insulated by a covering layer 114. The measurement site 100 comprises a working electrode region 122 which is connected by a conducting track 116 to a contact area 118 also remote from solution. Referring to FIG. 9, details of the measurement site are as follows. The working electrode area 122 is defined by an opening in an insulating covering layer 124. The conductor track 116 exposed in the opening is coated with materials chosen to give a stable electrochemical potential in a chloride ion-containing cell support solution, preferably an Ag/AgCl electrode formed from a layer 130 of silver coated in turn with a layer 132 of silver chloride. Surrounding the opening in the layer 124 is a region 134 to which the membrane of the object 140 can form a gigaseal. If the material forming layer 124 is itself suitable for formation of a gigaseal then no further modification to it is needed in this region. An additional material 134 is advantageously provided so as to enhance sealing to the object. Examples of such sealing material include silica or glass, preferably deposited by sputtering. The design of the measurement site is such that, in contrast to the situation in the prior art, when the object is sealed to the seal region, no close proximity of seal is needed between the top surface of the electrode (here shown by the surface of layer 132) and the object membrane. In fact, a layer of solution is advantageously incorporated into the space 142 between the surface of layer 132 and the object membrane. This layer of solution acts to apply to the object membrane a well-defined potential derived from the potential of the electrode and also to maintain next to the membrane a benign solution environment rather than the altered environment typical in prior art methods of binding cells to electrodes.

In use, an AC potential is applied to electrode 122 with respect to a distant reference electrode, for example electrode 108 in FIG. 10, or another electrode dedicated for the purpose, at a frequency that will create a positive DEP effect on objects in a suspension above it. The AC field will diverge strongly above the electrode in the same way as from the aperture in previous embodiments; objects will be drawn towards the electrode by positive DEP and the strong divergence of the field near the electrode will mean that they will tend to reach the space directly above the electrode. On being drawn down towards the electrode they encounter the sealing region and form a gigaseal to it, the seal encircling the electrode. Quality of the seal can then be checked by conventional methods known in electrophysiology. Modifications can be made to the embodiment in FIG. 9 to improve the likelihood of sealing and quality of the seal, for example the surface of the seal material 134 is advantageously raised above the surface layer 132 of the electrode. This acts to keep the cell membrane away from the surface of the electrode, which is advantageous in that the tendency of silver ions to poison cell metabolism is reduced. To this end a further material, for example a hydrogel which contains an electrolyte, can be included overlying the surface of the Ag/AgCl electrode so as to reduce the diffusion of Ag+ ions in solution towards the cell.

Location of objects by DEP, as opposed to location by Electrophoresis (EP) disclosed in our earlier application WO 01/25769, is advantageous in that the size of the measuring electrode encircled by the adhesion region is necessarily small—typically 5 um diameter or less for a typical mammalian cell—and the electrode is necessarily a reversible one in order to establish a stable measurement potential versus the solution. Therefore the capacity of the electrode to carry current is limited by conversion of the material between its oxidised and reduced forms (Ag to AgCl and vice-versa). This limits the amount of current that can be passed in a given DC direction, and hence the degree to which electrophoresis can be used to locate the cell. AC DEP avoids this problem however. The capacity of a small electrode is sufficient for a programme of electrophysiological measurements.

FIG. 11 shows a further embodiment in which a measurement site 100 is provided on a substrate 102 as before, with similar parts numbered similarly as in FIG. 9 and 10. The measurement site in FIG. 11 is envisaged as being included in a test device similar to that shown in FIG. 10. Additionally, in FIG. 11 a further electrode 150 is provided which wholly or substantially surrounds the working electrode 122. Electrode 150 is intended to provide a positive DEP attraction to draw down the object to the measurement site, and is connected to external circuitry by a conductive track 152 leading to a contact area 156, isolated from solution by an insulating layer 154. This embodiment has the advantage that the working electrode is not used for the DEP object location; therefore avoiding passing through the electrode the current which flows during this process, which while it is AC may still increase the rate of dissolution of the AgCl electrode surface and hence increase the possibility of poisoning the cell by Ag+ ions in solution [2]. A layer of seal material 134 is coated over the DEP electrode 150 to give a seal surface at which the cell can form a gigaseal after it has been drawn towards the electrode.

In further embodiments (not shown, but readily appreciable from the above embodiments), further location electrodes are provided surrounding the central electrode 150 in the same manner as in the earlier embodiments comprising an aperture in FIGS. 4-8 above. The movement of objects by means of negative DEP TWD towards a central area where they can be located, and a gigaseal formed, using positive DEP is advantageous in a similar way.

In the embodiments shown above in FIGS. 9 to 11, the complete system shown in FIG. 2, and the operating sequence, are modified slightly. As there is no aperture to a second liquid-filled compartment, use of suction to locate the cell, assist gigaseal formation or achieve whole-cell configuration is not possible. The first must be achieved by DEP alone, EP as disclosed in our earlier application WO 01/25769, or a combination of the two; formation of the gigaseal can be assisted by a potential difference between measuring and reference electrodes. Whole-cell configuration is achieved by a potential difference pulse between measuring and reference electrodes, and/or application of a pore-forming compound in the vicinity of the measuring electrode. The parts of the apparatus and operating sequence above relevant to application of liquid flow at the rear side of the apparatus, or control of pressure differences across the aperture, are simply omitted. Other aspects, for example detection of the object at the measuring site or feedback control of the location process, are applicable.

Other embodiments are within the scope of the appended claims.

1. An apparatus for making electrical measurement on an ion channel-containing object (2) in a medium, comprising:
a substrate (12) having a first surface defining a boundary of a first compartment (36) adapted for retaining a first solution, on which first surface is located one or more measurement sites (1), each site comprising: an aperture (30) in the first surface communicating with a second compartment adapted for retaining a second solution; an adhesion region (18) surrounding the aperture to which the object can adhere so as to form a high-resistance seal between the first compartment (36) and the second compartment (6);
a first measurement electrode (8) in said first compartment which, in use, contacts the first solution;
a second measurement electrode (16) in the second compartment which, in use, contacts the second solution;
measuring means (200, 242) electrically connected to the first and second measurement electrodes (8, 16) adapted to make electrical measurements on the object (2) adhered to the adhesion region at the measurement site; and
object location means (246), including a first location electrode (8, 40, 50, 60 . . . ), and adapted to provide an AC signal to the electrode in order to create an AC field in the first solution, which field acts to move the object towards the measurement site by dielectrophoresis.

2. Apparatus according to claim 1 in which the object location means (246) further comprises a second location electrode (40) in the first or second compartment.

3. Apparatus according to claim 1 or claim 2 in which the first measurement electrode (8) and the first location electrode are provided as a single electrode structure.

4. Apparatus according to claim 1 or claim 2 in which the second measurement electrode and the first location electrode are provided as a single electrode structure.

5. Apparatus according to claim 1 or 2 in which one of said measurement electrodes is electrically common to more than one of said measurement sites.

6. Apparatus according to claim 1 or 2 in which the adhesion region (18) comprises a first area (44) immediately surrounding the aperture (30), to which an object (2) may adhere, the adhesion region being surrounded by a second area (46) to which objects do not adhere.

7. Apparatus according to claim 6 in which the diameter of the aperture (30) is 5 microns or less.

8. Apparatus according to claim 7 in which the diameter of the aperture (30) is 2 microns or less.

9. Apparatus according to claim 6 or claim 7 in which the first area has a diameter of 10 microns or less.

10. An apparatus for making electrical measurement on an ion channel-containing object (140) in a medium, comprising:
a substrate (102) having a first surface which, in use, is contacted by a first solution, and on which is located one or more measurement sites (100), each site comprising: a first measurement electrode (130); an adhesion region (134) surrounding the first measurement electrode to which the object can adhere so as to form a high-resistance seal between the first measurement electrode and the first solution; and a conductive track (116) for connecting the first measurement electrode to a measuring instrument while keeping it insulated from the first solution;
a second measurement electrode (108) which, in use, is in contact with the first solution;
measuring means (200, 242), electrically connected to the first measurement electrode and the second measurement electrode, and adapted to make electrical measurements on an object (140) adhered to the adhesion region at the measurement site;
object location means (246), including a first location electrode (150) on the substrate and adapted to provide an AC signal to the location electrode in order to create an AC field in the first solution, which field acts to move the object towards the measurement site by dielectrophoresis.

11. Apparatus according to claim 10 in which the first location electrode (150) is substantially surrounding or adjacent to the adhesion region.

12. Apparatus according to claim 10 or claim 11 in which the first location electrode and the second measurement electrode are formed as a single electrode structure (108).

13. Apparatus according to claim 10 or 11 in which the adhesion region (134) comprises a first area immediately surrounding the first measurement electrode, to which an object may adhere, the first area being surrounded by a second area to which objects do not adhere.

14. Apparatus according to claim 13 in which the diameter of the first measurement electrode is 5 microns or less.

15. Apparatus according to claim 14 in which the diameter of the first measurement electrode is 3 microns or less.

16. Apparatus according to claim 13 in which the first area has a diameter of 10 microns or less.

17. Apparatus according to claim 10 in which the adhesion region (134) and the first measurement electrode (130) are spatially separated such that, in use, a containment volume (142) is formed between an object (140) adhered to the adhesion region and the first measurement electrode.

18. Apparatus according to claim 1 or 10 in which the object location means (246) further includes entrainment means (222) for generating a flow of the first solution within the first compartment (36).

19. Apparatus according to claim 18 in which said entrainment means comprises a pump.

20. Apparatus according to claim 1 or 10 in which the measuring means (200, 242) further comprises a pulse generator (246) adapted to apply an electrical pulse, or series of pulses, between said measurement electrodes until a predetermined level of impedance between the electrodes is detected.

21. Apparatus according to claim 1 or 10 further including dispensing means (221) for delivery of the objects and first solution to the vicinity of the measurement sites.

22. Apparatus according to claim 21 in which the dispensing means comprises a plurality of microchannels formed in the first surface of said substrate, each communicating with a measurement site.

23. Apparatus according to claim 1 or 10 in which the measurement sites further include confinement walls (38, 106) separating the measurement site from adjacent measurement sites.

24. Apparatus according to claim 23 in which the confinement walls comprise deposited or adhered layers applied to the substrate and patterned thereon to define said measurement sites.

25. Apparatus according to claim 1 or 10 further comprising one or more location electrodes arranged about each measurement site in a configuration so as to enable application of a diverging electrical field about the measurement site.

26. Apparatus according to claim 25 further including a plurality of electrodes arranged about each measuring site adapted to generate a negative dielectrophoretic force to drive objects toward the vicinity of the respective measuring site.

27. Apparatus according to claim 1, wherein said object location means further includes entrainment means for generating a flow of first solution through said aperture.

28. A test structure for use in making an electrical measurement on an ion channel-containing object in a medium, comprising:
a substrate (12) having a first surface on which is located one or more measurement sites (1), each measurement site comprising:
an aperture (30) in the first surface communicating with a second surface of the substrate;
an adhesion region (18) surrounding the aperture to which the object can adhere so as to form a high-resistance seal thereto;
at least one location electrode (40, 50, 60 . . . ), substantially surrounding or adjacent to the adhesion layer region, configured for the application of an AC signal thereto so as to create an AC field in the proximity of the measurement site, which field acts to move an object towards the measurement site by dielectrophoresis.

29. A test structure according to claim 28 further including a first measurement electrode (8) formed on or proximal to the first surface; and a second measurement electrode (16) formed on or proximal to the second surface.

30. A test structure according to claim 28 or claim 29 in which the location electrode (40) comprises an electrically conductive layer on the substrate around the aperture, and the adhesion region comprises a dielectric layer (44) over the location electrode.

31. A test structure according to claim 28 or claim 29 further including an anti-adhesion region (46) surrounding the adhesion region.

32. A test structure according to claim 28 or 29 in which the diameter of the aperture is 5 microns or less.

33. A test structure according to claim 32 in which the diameter of the aperture is 2 microns or less.

34. A test structure according to claim 28 or 29 in which the adhesion region has a diameter of 10 microns or less.

35. A test structure according to claim 28 or claim 29 including a plurality of measurement sites each separated by an insulating wall (38).

36. A test structure according to claim 35 in which the insulating walls comprise a field layer deposited on said substrate, a plurality of wells in said field layer each defining one of said measurement sites.

37. A test structure according to claim 28 in which the aperture (30) is formed in a membrane material (4) on the first surface bridging a substantial portion, but not all, of a larger via formed in the substrate material and in which the location electrode (40) is formed on an underside of the membrane material (31).

38. A test structure according to claim 28 or claim 29 further including a plurality of location electrodes arranged in an array proximal to each measurement site, in a configuration adapted to enable application of travelling wave dielectrophoresis to objects so as to drive them towards the aperture.

39. A test structure according to claim 38 in which the electrode array comprises a series of concentric tracks (50) extending around the measurement site.

40. A test structure according to claim 39 in which the concentric tracks are partially circumferential around the measurement site.

41. A test structure according to claim 39 in which the concentric tracks are fully circumferential around the measurement site.

42. A test structure according to claim 38 in which the electrode array comprises a series of concentric spiral tracks (60).

43. A test structure according to claim 42 in which the electrode array further includes a conductive track to said at least one location electrode.

44. A test structure according to claim 38 in which the electrode array comprises a linear array.

45. A test structure for use in making an electrical measurement on an ion channel-containing object in a medium, comprising:
a substrate (12) having a first surface on which is located one or more measurement sites (1), each measurement site comprising:
a first measurement electrode (130);
an adhesion region (14) surrounding the first measurement electrode to which the object can adhere so as to form a high-resistance seal thereto; and
at least one location electrode (40, 50, 60 . . . ), substantially surrounding or adjacent to the adhesion layer region, configured for the application of an AC signal thereto so as to create an AC field in the proximity of the measurement site, which field acts to move an object towards the measurement site by dielectrophoresis, so that it adheres to the adhesion region to form a high-resistance seal.

46. A test structure according to claim 45 further including a second measurement electrode (108) on the first surface separated from said first measurement electrode at least by said adhesion region.

47. A test structure according to claim 45 or claim 46 in which the diameter of the first measurement electrode is 5 microns or less.

48. Apparatus according to claim 47 in which the diameter of the first measurement electrode is 3 microns or less.

49. Apparatus according to claim 45 or 46 in which the adhesion region has a diameter of 10 microns or less.

50. Apparatus according to claim 45 or claim 46 in which the adhesion region (134) and the first measurement electrode (130) are spatially separated such that, in use, a containment volume (142) is formed between an object (140) adhered to the adhesion region and the first measurement electrode.

51. A test structure according to claim 45 further including a plurality of location electrodes arranged in an array proximal to each measurement site, in a configuration adapted to enable application of travelling wave dielectrophoresis to objects so as to drive them towards the first measurement electrode.

52. A test structure according to claim 51 in which the electrode array comprises a series of concentric tracks (50) extending around the measurement site.

53. A test structure according to claim 52 in which the concentric tracks are partially circumferential around the measurement site.

54. A test structure according to claim 52 in which the concentric tracks are fully circumferential around the measurement site.

55. A test structure according to claim 51 in which the electrode array comprises a series of concentric spiral tracks (60).

56. A test structure according to claim 55 in which the electrode array further includes a conductive track to said first measurement electrode.

57. A test structure according to claim 51 in which the electrode array comprises a linear array.

58. A method for making electrical measurements on an ion channel-containing object in a medium, comprising the steps of:
supplying a first solution comprising the objects to be measured in suspension to a first surface of a substrate, the substrate having an aperture therein communicating with a second surface of the substrate;
supplying a second solution to the second surface so as to establish fluid contact between the first and second surfaces;
testing that fluid contact has been achieved between first and second electrodes respectively located on or proximal to the first and second surfaces, by measuring electrical continuity therebetween; and
driving an object to be measured in the first solution to a measurement site having an adhesion region surrounding the aperture by dielectrophoresis.

59. The method of claim 58 further including the step of testing the resistance of the seal at the measurement site on the substrate by measuring electrical impedance between said first and second electrodes.

60. The method of claim 58 or claim 59 further including the steps of establishing the measurement configuration for the object by means of one or more electrical pulses applied between the first and second electrodes, and performing measurements on said object.

61. The method of claim 58 further including the step of enhancing adhesion of the object to the adhesion region by applying reduced pressure to the second solution.

62. The method of claim 58 further including the step establishing the measurement configuration for the object by applying a pore-forming compound to the area of the object enclosed by the high-resistance seal and in contact with the second solution.

63. The method of claim 58 further including the step of supplying to the vicinity of the object test compounds in solution while operating the measuring means to observe the electrical response of the object to the presence of the compound and to electrical stimuli supplied by the measuring means.

64. A method for making electrical measurements on an ion channel-containing object in a medium, comprising the steps of:
supplying a first solution comprising the objects to be measured in suspension to a first surface of a substrate, the substrate having a first measurement electrode located thereon, and an adhesion region surrounding said first electrode;
providing a second measurement electrode in electrical contact with said first solution; and
driving an object to be measured in the first solution to the measurement site by dielectrophoresis, to cause the object to adhere to the adhesion region so as to form a high-resistance seal therewith.

65. The method of claim 64 further including the step of testing the resistance of the seal at the measurement site on the substrate by measuring electrical impedance between said first and second electrodes.

66. The method of claim 64 or claim 65 further including the step of establishing the measurement configuration for the object by means of one or more electrical pulses applied between the first and second electrodes, and performing measurements on said object.
